(19) United States
(12) Patent Application Publication
(10) Pub. No.: US 2015/0355446 A1
(43) Pub. Date: Dec. 10, 2015

(54) METHOD FOR THE MICROSCOPE IMAGING OF SAMPLES ADHERING TO BOTTOMS OF FLUID FILLED WELLS OF A MICROTITER PLATE

(71) Applicants: Thorsten Kues, Bovenden-Eddigehausen (DE); Peter Schoen, Goettingen (DE)

(72) Inventors: Thorsten Kues, Bovenden-Eddigehausen (DE); Peter Schoen, Goettingen (DE)

(73) Assignee: CARL ZEISS MICROSCOPY GMBH, Jena (DE)

(21) Appl. No.: 14/732,018

(22) Filed: Jun. 5, 2015

(30) Foreign Application Priority Data
Jun. 5, 2014 (DE) 102014107933.7

(51) Int. Cl. G02B 21/06

(52) U.S. Cl. CPC G02B 21/06

(57) ABSTRACT

A method for microscope imaging of a sample, wherein a sample well is filled with liquid with the sample adhered to the bottom, illuminating and imaging the sample well from the underside and capturing at least one sample image thereof, wherein any inhomogeneity of the illumination is equalized by providing a test well with the same structure filled with liquid but no sample, making a reference measurement of the test well by illuminating the test well, imaging the illuminated test well from the underside and capturing a reference image which covers the entire bottom, analyzing the reference image to determine a brightness correction specification based on brightness fluctuation, and using the brightness correction specification to correct the sample image, including determining a position of at least a part of the sample image and using a value of the brightness correction specification assigned to the position.

### RELATED APPLICATION

The present application claims priority to German Application No. 102014107933.7, filed Jun. 5, 2014, which is hereby incorporated herein in its entirety by reference.

### FIELD OF THE INVENTION

The invention relates to a method for microscope imaging of a sample, wherein a sample well is provided which is filled with liquid and comprises well structure including a bottom and wherein the sample adheres to the bottom of the sample well, wherein:

(a) the sample well is illuminated with illumination radiation and
(b) the bottom of the illuminated sample well is imaged magnified from an underside of the sample well and at least one sample image of the bottom of the sample well is captured.

### BACKGROUND OF THE INVENTION

Microscopy of live cells plays an important role in biomedical sciences. These cells are frequently cultivated in microtiter plates which have wells. However, other, individual wells are also used. The cells are located on the bottom and are surrounded by a culture medium. They generally undergo microscopy with an inverted microscope; in this microscope the objective is located beneath the bottom of the well. The sample can be illuminated via incident light or transmitted light. For transmitted-light imaging a light source is provided above the well. However, as biological cells contain only few absorbent constituents, bright-field transmitted-light images are typically of low contrast. With the help of various transmitted-light contrasting methods, such as e.g. phase contrast, DIC, inter alia, a small difference in refractive index of the individual cell constituents from one another and from the surrounding medium can be converted into an intensity difference which then provides a high contrast transmitted-light image.

The invention relates in particular to the transmitted-light microscopy of samples which adhere to the bottom of wells of a microtiter plate. The bottoms are illuminated in transmitted light and imaged on a microscope in high resolution. This type of microscopy differs from the usual imaging, customary in other applications in the state of the art, of an entire microtiter plate, as e.g. in DE 10200541 A1. If the bottoms are imaged individually or in small groups magnified in transmitted light, the requirements on the quality of the transmitted-light illumination are much higher. This is true in particular in respect of the named transmitted-light contrasting method.

The field of the invention is also to distinguish same from so-called fluorescence readers which check whether or how strongly the liquid fluoresces in a well of a microtiter plate. Here, too, generally a detection of all the wells of a microtiter plate takes place simultaneously. Moreover, the quality of the illumination of the bottoms is irrelevant in these applications. U.S. Pat. No. 6,074,614 relates to such use of microtiter plates and provides a cover plate which has a plurality of cylindrical projections suitable for microtiter plates, which cylindrical projections are immersed in the potentially fluorescing liquid of the microtiter plate. The aim is to guarantee as uniform as possible a length of beam path through the wells of the microtiter plate when exciting and reading out fluorescence. The question of illumination of the bottom of a well of a microtiter plate does not play any role.

In microscopy, the image quality depends not only on the imaging optics used but also on the quality of the illumination. The imaging system consisting of objective, tube lens, eyepiece or camera images the conditions in the sample plane as accurately as possible. These conditions are influenced by the sample itself and by the illuminating light field. This light field is characterised by an intensity distribution in the object field (illumination) and an illumination angle distribution, i.e. light from which solid angle reaches each individual point of the object field (numerical aperture (NA) of the illumination). The illumination effects are generally, however, not the purpose of the investigation, but the sample is of interest. Therefore, it is intended to achieve as homogeneous an illumination as possible to the effect that each point of the object field is illuminated with light of an identical angular spectrum. This applies both to transmitted-light illuminations in which the light radiates through the sample and is collected by the imaging objective on the other side and to incident-light illuminations in which the illumination is irradiated through the imaging objective.

In transmitted light, these conditions are best achieved by a Koehler type illumination. However, even then the illumination is not perfectly homogeneous. With ocular-based examinations this is not critical, as on the one hand the human eye perceives small differences in intensity only poorly and on the other hand always only one image is being looked at, specifically the current field of vision. Even if the intensity at the edge of the field of vision visibly decreases slightly this is no problem in most cases. In observations with camera-based image capture, the situation is far more critical. Small differences in intensity are detected better and are then considered as interference. This effect occurs in particular in panorama/stitching images. In extreme cases stitching algorithms can require more time for image registration or registration even becomes impossible.

In order to avoid such effects, a shading correction can be carried out. This is done e.g. by capturing reference image without a sample. This reference image contains the illumination artifacts which interferes with a perfect illumination and imaging. These are e.g. the inhomogeneous illumination, already described further above, and also dust and dirt which can be located on individual lenses, mirrors or other elements in the beam path, just like any imperfect adjustment of the beam path. All these effects which are summarised here under the term “shading” are present in each image which is captured with this beam path. If the reference image is known, the sample images can be corrected by means of a so-called shading correction. Such a method is described for example in US 2010/0188497. There are also methods in which the shading can be identified and removed without prior capture of a reference image. Reference may be made on this point to WO 13/094273.

However, all these methods recognise and correct only beam path-related shading, i.e. a shading which is independent of the sample position, but is fix within the reference system of the beam path. Any displacement of the sample about one or more object fields in one direction does not change anything in respect of this beam path-related shading. The reference image thus does not vary with a sample displacements.

In US 2003/039402 a method is described which makes it possible to remove scratches or other artifacts in a scanned image. This method can also be transferred in principle to microscopy and would make it possible to recognise and remove specific artifacts such as small hairs in the sample plane. However, in order to detect shading, a priori knowledge about the type of artifacts would be needed, because otherwise the image analysis cannot decide which elements of the image can be assigned to the sample and which are shadings. The method also failed with a shading which is characterised not by sharply outlined structures, but by spatially extended brightness gradients.

### SUMMARY OF THE INVENTION

Therefore, the invention provides a method for the microscope imaging of a sample which adheres to the bottom of a well, such that the illumination of the bottom is improved for imaging.

The invention provides a method for microscope imaging of a sample, wherein a sample well is provided which is filled with liquid and comprises well structure including a bottom and wherein the sample adheres to the bottom of the sample well, wherein:

(a) the sample well is illuminated with illumination radiation and
(b) the bottom of the illuminated sample well is imaged magnified from an underside of the sample well and at least one sample image of the bottom of the sample well is captured, wherein any inhomogeneity of the illumination of the bottom, caused by the well, is corrected for by the following steps:
(c) a test well is provided which is filled with liquid and has the same well structure as the sample well, but no sample,
(d) a reference measurement is carried out on the test well by illuminating the test well with the illumination radiation, imaging the bottom of the illuminated test well form an underside of the test well and capturing a reference image which covers the entire bottom of the test well,
(e) the reference image is analysed to determine a brightness correction specification, wherein the brightness correction specification indicates a brightness fluctuation being a function of a location on the bottom of the test well,
(f) the brightness correction specification is used to correct the sample image, wherein a position of at least a part of the sample image on the bottom is determined and a value of the brightness correction specification assigned to this position on the bottom is used.

The invention is based on the knowledge that a sample vessel-based shading which is fixed in relation to the reference system of the sample vessel is not recognised by the described methods and consequently cannot be corrected.

A sample vessel-based shading exists if the structure of the sample vessel itself leads to shading. This occurs in particular e.g. in small vessels (microtiter plates), as described further below. If the sample is moved, this shading also shifts. Thus it is always at the same point of a sample vessel-based reference system, but cannot be assigned to any fixed position of a beam path-based reference system. Brightness gradients occur in particular in the transmitted-light illumination of microtiter plates. Microtiter plates are sample vessels which are used in particular in observation of living cells. These plates are equipped with a defined number of wells, e.g. 24, 96 or 384, at regular intervals. A sample, e.g. cells or embryos, can be introduced into each of these wells. For microscope observation the wells are provided with a transparent bottom made e.g. of polystyrene or glass. The optical properties of the wells have a considerably interfering effect on the illumination in transmitted light. Hereinafter, this effect will be explained using a microtiter plate which has 96 wells with a height of 11 mm and a diameter of 7 mm.

The upper edge of the well trims the cone of light of the transmitted-light illumination from which cone light can reach a specific point of the bottom of the well and can be detected by the imaging objective after passing through the bottom. Depending on whether a point is in the centre of the well bottom or closer to the edge, the usable cone of light is different, i.e. the points of the bottom of the well are illuminated from different numerical apertures. This results in a sample vessel-dependent shading, the effect of which becomes greater, the more the illumination cone of light is trimmed by the well and the less evenly the illumination intensity is distributed over the different angles of illumination. When, on the contrary, the numerical aperture of the imaging objective is large enough to catch all the different illumination cones and the illumination comprises an approximately equal intensity in each of these cones, the illumination of the bottom of the well remains homogeneous, but the edge of the well still trims the illumination light.

However, the aqueous medium in which the sample is located forms a meniscus on its surface. The boundary surface between air and medium is thus curved. The radius of the meniscus depends on the type of liquid, wall material and coating of the wells, as well as on the filling method, thus whether dry or already wet wells have been filled, whether the liquid is stirred etc. In the majority of cases the liquid is drawn slightly upwards along the wall of the wells, while the level of liquid is deeper in the centre of the wells.

This has the effect that a parallel beam bundle diverges after passing the meniscus. This divergence is more stronger the smaller the development of the radius of the meniscus is. This is not a major problem with imaging objectives of high NA because the diverging beams can still be detected. However, numerous applications require weakly magnifying objectives which image a large field, to allow an overview image of the sample. For example a single image of a 2.5×-magnifying objective covers a whole well of 96 wells a microtiter plate.

However, weakly magnifying objectives typically have only a low NA, e.g. 0.08 or 0.12. The NA (NA=n*sin(α)) defines the maximum angle α, which a beam can form with the optical axis for imaging by the imaging objective. For this, n is the refractive index of the medium between imaging objective and sample. With weakly magnifying objectives this medium is generally air, thus n=1. All illumination beams which are refracted to larger angles than the critical angle established by the objective NA do not reach the imaging objective, thus. Even if illumination light reaches each part of the bottom of the well, the meniscus effect creates an inhomogeneously illuminated image as, depending on the angle of incidence, light from the sample does not reach the objective in equal proportions.

The captured image, in consequence, usually has a bright centre and dark edge regions. This creates a sample vessel-based shading which cannot be corrected for by the known shading correction methods.

The invention uses a brightness correction specification which is a function of the location on the bottom of the well. The term “well” or “sample well” is used to indicate a sample vessel. It can be both an individual vessel and a well of a microtiter plate. When reference is made in the following description to the singular (“well”) then both the use of individual vessels and of individual wells of a microtiter plate is meant.

The test well corresponds to the structure of the sample vessel, which contains the sample, up to the difference that no sample is present in the test well. If the sample adhering to the bottom of the sample well is in a culture solution, i.e. there is also a liquid found in the well, it is preferable to provide this liquid also in the test well. The test well should produce precisely those optical conditions, i.e. influencing the illumination radiation, which also prevails in the sample well—but without a sample. As a result, the brightness correction specification which is a function of the location at the bottom of the well, can be determined by means of the test well and then used for correcting an uneven brightness distribution when imaging the sample in the sample well.

The brightness correction specification can be provided in different ways, amongst others:

In a first embodiment, the bottom of the test well is imaged to several partial images and a reference image is obtained by combining in the partial images. The brightness correction specification is then essentially the brightness distribution over the whole bottom of the test well, i.e. over the reference image. Imaging a sample well provides a sample image. To correct a sample image which shows only a section of the bottom of the well because of the magnification, the position of the sample image on the bottom is determined. A correspondingly selected section of the reference image then provides the required brightness correction data for correcting sample image.

A second embodiment gives a functional description of the brightness distribution in the reference image. For each location at the bottom of the test well (for example for each pixel) a correction factor is determined in the reference image which gives an additive or multiplicative difference to an even brightness distribution. The sample image is then corrected by determining its position on the bottom, reading out the corresponding value(s) of the correction factor for this position from the brightness correction specification and applying the correction factor (either additively or multiplicatively, depending on the design of the factor). This can be done on a pixel basis or on basis of regions of the sample image.

In a third embodiment, which can be used in particular in wells which have a circular cross-section, the brightness correction specification comprises a correction factor (again either additively or multiplicatively) which depends exclusively on the distance from the centre of the bottom of the test well. For this embodiment one needs only to take images in the reference measurement of step (d) which cover an area along a radial coordinate from the centre of the bottom of the test well out to its edge. The sample image is brightness corrected in step (f) in this embodiment in that the radial coordinate of each pixels of the image, i.e. the distance from the centre of the bottom of the well, is determined. Reading out the corresponding correction value from the brightness correction specification and applying this correction value to the sample image gives the brightness correction.

It is understood that the features mentioned above and those which will be explained in the following are applicable not only in the stated combinations, but also in other combinations or singly, without departing from the spirit and scope of the present invention.

### BRIEF DESCRIPTION OF THE DRAWINGS

The invention is explained by way of example in greater detail in the following with reference to the attached drawings, which may also disclose features of the invention. There are shown in:

FIG. 1 two schematic representations to illustrate the influence of the numerical aperture of an objective in transmitted-light microscopy of samples which adhere to a bottom of a microtiter plate,

FIG. 2 five schematic representations similar to FIG. 1 to illustrate the interrelation of imaging and numerical aperture of the illumination,

FIG. 3 a schematic representation of a microscope for imaging samples which are located on the bottoms of wells of a microtiter plate,

FIG. 4 a function to illustrate the intensity distribution at the bottom of a well which is caused by influences of the well on the illumination,

FIG. 5 a flow chart to explain the general principle of the correction of an uneven illumination of the bottom of a well,

FIG. 6 a schematic representation to explain the correction according to FIG. 5 in a first embodiment,

FIG. 7 a flow chart to explain a second embodiment and

FIG. 8 a schematic representation to explain a third embodiment.

### DETAILED DESCRIPTION OF THE DRAWINGS

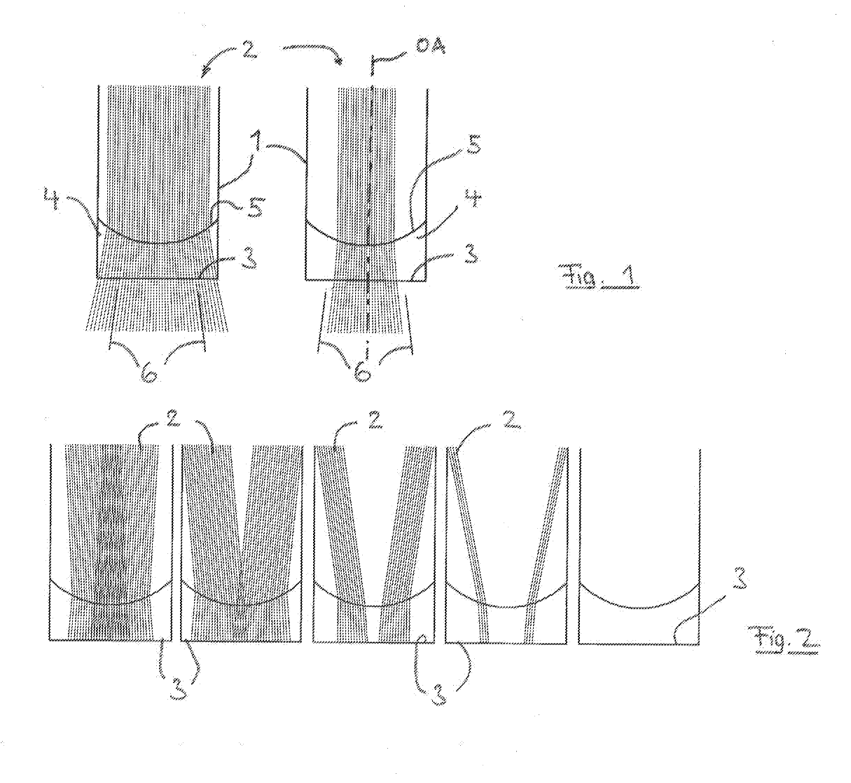

FIG. 1 shows, schematically, a sectional view through a well 1 of a microtiter plate which is illuminated along an optical axis OA by an illumination beam bundle 2. On a bottom 3 of the well there is a sample, for example a cell culture, which sample is not shown in more detail. A fluid 4, for example a culture medium for the cell culture, which fluid forms a meniscus 5 on its surface, is in the well.

In FIG. 1, the illumination beam bundle 2 is irradiated from above. The bottom 3 illuminated in this way is imaged in transmitted light by an imaging objective which has a detection cone 6.

The sample in the well 1 is generally in an aqueous environment, e.g. a simple buffer or a culture medium, in order to observe living cells. On its surface, this liquid 4 forms the meniscus 5, thus the boundary surface between air and medium is curved. The radius of the meniscus 5 depends on the type of liquid 4, wall material and coating of the well 1, as well as on the history of the filling, thus whether dry or already moist wells 1 have been filled, whether the liquid is stirred, etc. In most cases, the liquid 4 is drawn slightly upwards along the wall of the well, while the level of liquid is deeper in the centre of the well.

When a parallel illumination beam bundle 2 passes the meniscus 5, the bundle is not parallel anymore but is made to diverge. Such divergence is more pronounced the smaller the radius of the meniscus 5. In objectives with high NA which have a large detection cones 6, this is not a problem because the diverging beams may still be detected. However, applications often require low magnifying objectives to image a large field and to get an overview image of a bottom. For example a single image of a 2.5×-magnifying objective, images almost a whole bottom 3 of the well 1 of a microtiter plate with 96 wells 1.

Low magnifying objectives typically have only a low NA, e.g. 0.08 or 0.12. The NA=n*sin(α) defines the maximum angle α of the detection cone 6 to around the optical axis OA from which cone imaging by the objective is still possible. n is the refractive index of the medium between objective and sample. With weakly magnifying objectives this is generally air, thus n=1. All illumination beams which are refracted by the meniscus 5 to larger angles than the maximum angle established by the objective NA do not reach the objective. Even if illumination light reaches each part of the bottom 3 (as in the left-hand part of FIG. 1), the meniscus effect creates an inhomogeneous image as, depending on the angle of incidence, the transmitted-light illumination does not reach the objective in the same proportions for the whole bottom.

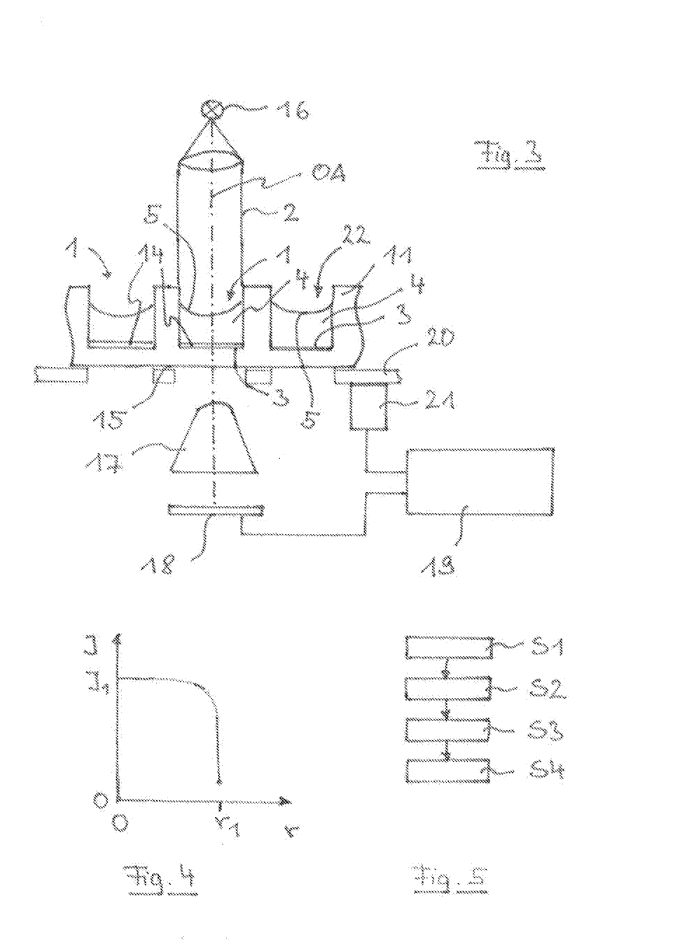

FIG. 1 assumes the ideal situation of a parallel illumination beam bundle 2. However, a typical transmitted-light illumination is not parallel but clearly has an angular range, often as broad as to the angle which is given by the numerical aperture (NA) of the illumination. For the aforementioned objective, where NA=0.12, beam bundles of other incident angles result in the illumination pattern shown in FIG. 2. In the five representations of FIG. 2, the numerical aperture of the illumination is 0.05; 0.1; 0.15; 0.2 and 0.25.

The illumination pattern is different for each angle of incidence on the bottom 3. However, it is true for all geometries that the edge areas are never, or less often, reached by beams which can be used by the objective. The captured image comes from the sum of all these individual beam bundles. Thus the image has a bright centre and dark edges. This consideration applies regardless of the type of transmitted-light illumination, thus regardless of whether it is Koehler type, critical or another type of illumination. The described effect remains, regardless of what is undertaken above the well 1.

FIG. 3 shows schematically a microscope for high-resolution imaging of samples 14 at bottoms 3 of wells of a microtiter plate 11. With reference to FIGS. 1 and 2, elements and components already described are given the same reference numbers in FIG. 3 in order to prevent the description from being repeated.

The microscope has an illumination beam source 16 which emits the illumination beam bundle 2 along the optical axis OA and through an illumination beam path onto the microtiter plate 11 from above. The bundle is aligned to the optical axis OA such that a well which contains a sample 14 to be imaged lies suitably in the illumination beam path, i.e. in illumination beam bundle 2. Light transmitted from the illuminated sample 14 is imaged from an underside 15 of the microtiter plate 11. A corresponding imaging beam path of the microscope extends from below the microtiter plate 11 through an objective 17 and to a detector 18 are shown by way of example. The imaging beam path is aligned to the optical axis OA, i.e. the illumination beam path lies along the same optical axis OA as the imaging beam path.

A controller 19 reads out data from the detector 18. In order to image the wells of the microtiter plate 11 individually, an underside 15 of the plate is supported on a sample table 20, which can be shifted via a drive mechanism 21 controlled by the controller 19 such that individual wells of the microtiter plate 11 can be aligned to the optical axis OA.

One of the wells of the microtiter plate 11 is provided as a test well 22. This well is identical to the remaining wells of the microtiter plate 11 with the single difference that there is no sample 14 at the bottom 3 of the test well 22. The illumination of the bottom 3 of the test well 22 is subjected to exactly the same conditions as the illumination of the bottoms 3 of the sample wells which contain sample 14.

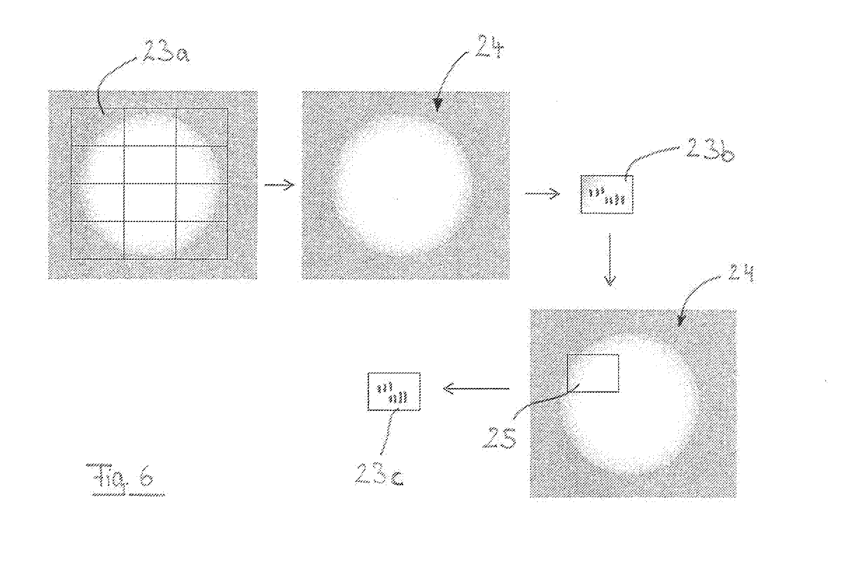

As already explained with reference to FIGS. 1 and 2, the well 1 affects how the bottom 3 of the well is illuminated. FIG. 4 shows this by way of an example in a diagram in which an intensity I of the illumination, i.e. the brightness on the bottom 3, decreases as a function of the distance from the centre of the well 1. The centre of the well can for example correspond to the position of the optical axis OA. A maximum brightness, i.e. an intensity I₁, is present there. The edge of the well which is by way of example assumed to be a circular cylinder is located on a radius r₁. Only the radial coordinate r is of importance due to the circular cylinder shape of the well. At the edge of the well, i.e. at r₁, the illumination intensity is minimal, e.g. zero. Intensity I remains almost constant over a longer extend while the distance r decreases from the optical axis OA and decreases towards the edge of the well, i.e. at the radial coordinate r₁. This intensity pattern of the illumination, which in the example of FIG. 3 is by way of example a transmitted-light illumination, does of course have an effect on the imaging of a sample 14. A similar intensity pattern is also given an incident-light illumination if the observation plane does not lie directly on the well bottom but looks somewhat further into the sample. The description given here can also always be applied to microscopes with incident-light illumination, e.g. illumination with is irradiated from the side of the imaging objective.

The decrease in intensity to the edge is called “shading” in the scientific literature. It is created not by the beam path of the microscope, but by the sample vessel. For correcting a beam path-based shading all methods known in literature can be used, which are not described again here. However, the sample vessel creates a sample vessel-based shading that can be removed from the sample image in the ways described below. In all these methods it is preferred to first remove any beam path-based shading (even if not being described below), with the result that only the sample vessel-based shading remains.

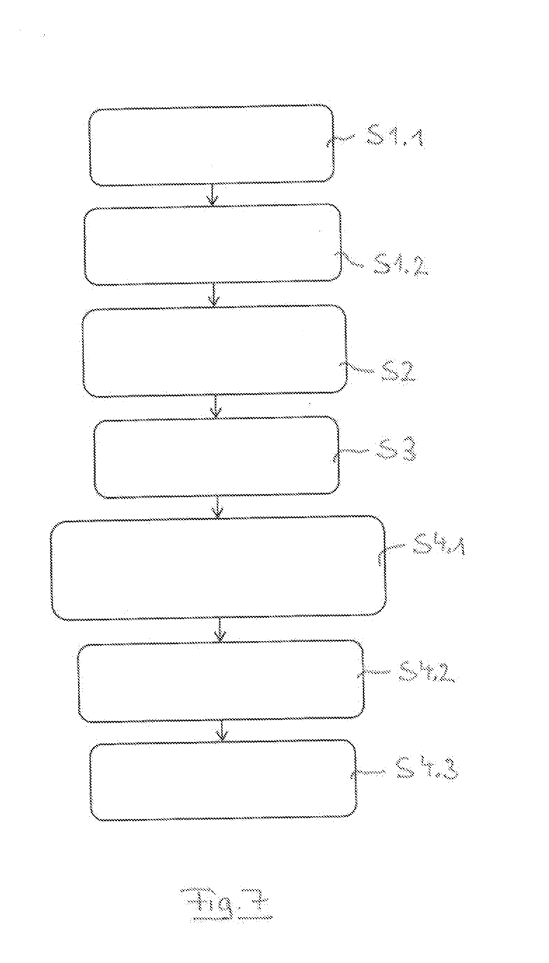

The sample vessel-based shading is removed according to a method which is shown schematically in FIG. 5 as a flow chart. FIG. 6 shows individual images occurring in the method. In a step S1 a test well 22 is placed in the illuminating and imaging beam paths of the microscope. A reference image of the bottom 3 of the test well 22, i.e. without sample 14, is taken. The resolution by the objective 17 is such that the object field of the objective 17 does not detect the entire bottom 3. Therefore, the imaging is done by taking in several individual images 23a and scanning the bottom e.g. in the form of a mosaic tile imaging. For scanning the test well 22 is displaced perpendicular to the optical axis OA and parallel to the bottom 3. The influence of the test well 22 on the illumination of the bottom 3 changes at every well position. This illustrates that the shading to be corrected is a sample vessel-based shading and not a shading which is brought about by the illumination beam path itself. That shading would be completely independent of the positioning of the well 22.

When scanning the bottom 3, the individual images 23a contain variations of the illumination of the bottom 3 characteristic of the position of the individual image 23a at the bottom 3. At the end of step S1, there is available a reference image 24 of the bottom 3 from the plurality of individual images 23a, for example in the form of a mosaic tile imaging.

In a subsequent step S2 the brightness distribution in the reference image 24 is determined. This provides a brightness correction specification specifying a deviation from an ideal homogeneous illumination. The specification depends on the location at the bottom 3 of the test well 22.

Steps S1 and S2 give a brightness correction specification. In the embodiment of FIG. 5 they come before the further steps S3 and S4, where S3 serves to subject the sample(s) to microscopy and a brightness correction (step S4). However, steps S1 and S2 need not necessarily be carried out before step S3. It is perfectly possible for steps S1 and S2 to create the brightness correction specification and for step S4 to carry out the brightness correction also at any time after step S3, and optionally only if it turns out that the imaging of the samples 14 is not satisfying without correction.

A sample well 1 is imaged in step S3, on the bottom 3 of which well 3 a sample 14 is located.

In a step S4 the sample image 23b obtained in step S3 corrected by using the brightness correction specification; step S4, thus, assumes that steps S1 and S2 have been carried out before-hand. In the correction it is determined first where on the bottom 3 the sample image 23b of step S3 lay. After acquiring this location information, the brightness correction which applies to this very location of sample image 23b is determined and utilized to correct the brightness of the sample image 23b, created in step S3. A corrected sample image 23c is obtained which is homogenised regarding illumination for influences of sample vessel-based shading.

In the embodiment, the whole sample vessel is scanned, e.g. in the form of a mosaic tile image with individual images 23a. Ideally, a test well 22 without a sample 14 is used here. When the sample vessel is a vessel in which the sample is located in a fluid medium, the medium is preferably present also in the test well 22. Consequently, the composed reference image 24 contains the sample vessel-based shading.

In order to subtract the shading from a sample image 23b with sample 14, it must be determined at what position of the bottom 3 the sample image 23b was captured. For this, elements of the sample vessel-based shading in the sample image 23b can be detected. If e.g. a part of the edge of the well 1 is visible in the sample image 23b, the corresponding section 25 of the reference image 24 can easily be read out and the shading subtracted from the sample image 23b.

The simplest method of correction consists of dividing the intensity values of the pixels of the sample image 23b by the intensity values of the corresponding pixels of the corresponding section 25 of the reference image 24 and then renormalizing the result. This approach is also known from methods for beam path-based shading correction. Here, one fundamental difference consists of acquiring a corresponding section of the reference image 24, i.e. from a larger overview image, matching on the position of the sample image 23b on the bottom 5.

In this way, a corrected sample image 23c is obtained which is corrected over the sample image 23b for influences of the sample vessel-based shading.

In this embodiment a case can occur that a clear localisation of the position of the sample image 23b at the bottom 3 and thus the choice of the corresponding section 25 of the reference image 24 is not clearly possible. If e.g. no clear edge of the sample vessel is visible in the sample image 23b because the sample field does not cover the edge, the sample vessel-based shading can still be present just as strongly without it being obvious what may be the suitable section 25 of the reference image 24 to be used for correcting the sample image 23b for shading.

Even in such case a correction is possible if the drive mechanism 21 of the sample table 20 gives a positional feedback of the positioning of the bottom 5. The xy coordinate of each point at which an individual image 23a was captured for reference image 24 is stored, i.e. the xy position of each point in the reference image 24 is known. If now the test well 22 is replaced by the sample well 1 with sample 14, the xy position does not change relative to of the well 1. Regardless of the position at which the sample image 23b is now captured, the suitable section 25 of the reference image 24 can be determined and the correction carried out as described above.

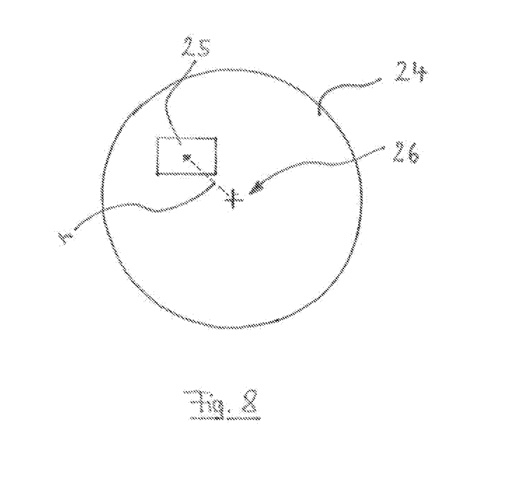

In sample vessels with a plurality of similar subunits such as e.g. a microtiter plate 11 with a plurality of similar wells 1, a single subunit—thus e.g. one well—is sufficient as a reference vessel, i.e. in the test well 22. The individual subunits are arranged in a fixed pattern which is known either from the manufacturer or can easily be measured out for oneself. Thus at each pair of xy table coordinates at which a sample image 23b is captured, the position of the sample image 23b relative to the respective well 1 can be decided directly and the suitable section 25 of the reference image 24 is chosen. One possible sequence of this is represented in FIG. 7 using the example of a microtiter plate 11.

In FIG. 7 there are steps which correspond to the flow chart of FIG. 5, characterised with the same reference numbers, wherein sub-steps are characterised by attaching a suffix. In a step S1.1 the centre (x₀, y₀) is sought for test well 22. Then, the reference image 24 of the bottom 3 of the test well 22, is obtained e.g. by a mosaic tile image.

In step S3 the brightness distribution of the reference image 24 is converted into a brightness correction specification, for example by calculating an additive or multiplicative correction factor giving a deviation from an average brightness. This brightness correction specification depends on the coordinates (x, y) in the reference image 24.

In step S2 the sample image 23b is captured at desired coordinates (x, y).

In step S4.1 a distance vector r from the centre of the sample image 23b to the centre of the well is calculated. This vector defines a corresponding section 25 in the brightness correction specification

In a step S4.2 a corresponding correction for the section 25 is read out from the brightness correction specification for this distance vector r.

Step S4.3 provides, finally, the correction of the sample vessel-based shading, by the brightness correction specification for the section, the centre of which has been defined being applied by the distance vector r.

The brightness correction specification can have either the form of the reference image 24 or the form of an image of correction values calculated therefrom, which when combined with the reference image (either additively or multiplicatively) gives a uniform brightness. If the brightness correction is provided as a reference image 24, the correction step S4 extracts the correction factors from the brightness distribution of the corresponding sections 25 of the reference image 24. If, however, the brightness correction specification already contains the correction factors, i.e. these factors have already been calculated from the reference image 24 and step S4 does not need to do that again. In respect of the importance for correction of the sample vessel-based shading, the terms reference image 24 and brightness correction specification are either identical (first option) or the reference image 24 represents a preliminary stage of the brightness correction specification (second option), wherein the conversion may be a simple mathematical operation (e.g. calculating a multiplicative or additive deviation from an average etc.).

FIG. 8 relates to the embodiment of FIG. 7. The reference image 24 represents a brightness correction specification. FIG. 8 shows the reference image 24. The centre 26 of the reference image 24 is known. The distance vector r is known for a given sample image 23b. The vector points to the centre of the sample image 23b. Now, a section 25 which has the same distance vector r and the same extension as the sample image 23b, is sought in the reference image 24. The section 25 is then the very part of the reference image (or the brightness correction specification) which is to be used for correction of the given sample image 23b.

If the wells are circular, a simplified embodiment acquires only a magnitude (length) of the distance vector r. To improve this embodiment, the magnitude of the distance vector can be read-out not only for the centre of a section 25 but for each pixel of the section.

A further possible embodiment gives the reference image 24 (or the brightness correction specification) in absolute pixel coordinates of the reference image 24. These pixel coordinates may be obtained by evaluating the positional feedback of the drive mechanism 21 of the sample table 20. Then, the coordinates of the pixels in the sample image 23b to be corrected are determined, wherein these coordinates refer to the reference image 24 (or the brightness correction specification). The correction factors corresponding to the coordinates are read out for each pixel from the reference image 24 (or the brightness correction specification) and applied to correct the sample image 23b.

The following modifications and refinements are optional for the invention:

The reference image 24 needs not be a composed image. It may be sufficient to save the individual images 23a and to calculate the suitable correction image of the sample 23b directly therefrom, as and when required.

The method can be implemented in other sequences of steps. For example, reference image 24 need not be captured until later to undertake the shading correction of the sample images 23b at a later time.

The case has been described in which only one part of the well is imaged on the detector 18 and therefore a plurality of individual images 23a are required to create the full reference image 24. With sufficiently weakly magnifying objectives and sufficiently small sample vessels or wells 1, however, imaging can take place also with an individual capture of the whole bottom 3; a mosaic tiled image is no longer necessary, then. Otherwise, the process described above still remains valid.

If the sample vessel is a circular vessel, it is not necessary to capture the whole vessel as a reference image 24 to correct effect of the shading, produced by the edge of the vessel. In circular vessels the shading is radially symmetrical relative to the centre of the vessel. This is the case e.g. in Petri dishes or circular wells 1 of a microtiter plate 11. Then, it is sufficient to capture a line from the centre of the vessel to the edge I₀(r) as reference image. To correct sample images, only the distance of each image pixel rₚ=(x,y) of the sample image from the centre of the vessel r₀ is required, i.e. r=|rₚ−r₀|. It does not matter whether the correction value I₀(r) is applied directly to the sample image 23b from these distances r for each pixel, or firstly a whole reference image 24 is built up with which the sample image is then corrected. In both variants, the sample vessel-based shading can be removed from the image of the sample easily.

Depending on the objective magnification and the size of the sample vessel used, the reference image 24 may consists of a very large number of individual images 23a, the capture of which requires a lot of time and the storage or processing thereof a lot of memory space. Generally, however, different objectives will show a differently accentuated sample-dependent shading. This is easily seen when considering a well 1 of a microtiter plate 11. As already explained further above, the liquid's meniscus 5 in the well 1 ensures that incident beams are refracted to higher angles, in particular those beams which pass the vicinity of the edge of the well. Usually, an objective 17 of low NA can no longer catch this light, thus the edge of the well appears clearly darker than the centre. On the other hand, an objective of high NA collects far more of this light, which is why the edge shading is less and the sample vessel-based shading is different. However, the difference exists only in the strength of the shading, not in its type. Both objectives measure this shading strength in the same object field. In principle, one image in the centre of the vessel and one at the edge is sufficient to calculate therefrom a shading strength factor which distinguishes the shadings effects seen by the two objectives from one another. The reference image 24 is taken with the lower magnifying objective and used also for the higher magnifying objective, taking into consideration the corresponding shading strength factor of this objective. In this way, the reference image 24 can be composed of clearly fewer individual images 23a, which saves time and storage as well as computing capacity. Moreover, with a change in objective, no new reference image need be captured to correct the sample vessel-based shading. One simply switches to the proper shading strength factor.

1. A method for microscope imaging of a sample, wherein a sample well is provided which is filled with liquid and comprises well structure including a bottom and wherein the sample adheres to the bottom of the sample well, wherein:
(a) the sample well is illuminated with illumination radiation and
(b) the bottom of the illuminated sample well is imaged magnified from an underside of the sample well and at least one sample image of the bottom of the sample well is captured, wherein any inhomogeneity of the illumination of the bottom, caused by the well structure and/or the liquid, is corrected for by the following steps:
(c) a test well is provided which test well is filled with liquid and has the same well structure as the sample well but no sample,
(d) a reference measurement is carried out on the test well by illuminating the test well with the illumination radiation, imaging the bottom of the illuminated test well form an underside of the test well and capturing a reference image which covers the entire bottom of the test well,
(e) the reference image is analysed to determine a brightness correction specification, wherein the brightness correction specification indicates a brightness fluctuation in the reference image as a function of a location on the bottom of the test well,
(f) the brightness correction specification is used to correct the sample image, wherein a position of at least a part of the sample image on the bottom is determined and a value of the brightness correction specification assigned to this position on the bottom is used.

2. The method according to claim 1, wherein in step (d) the reference image is captured by taking a plurality of partial images which each cover a section of the bottom wherein all partial images together cover the full bottom of the test well, and combining all partial images, and wherein in step (f) a location of the sample image at the bottom is determined, a corresponding section of the reference image is determined and the value of the brightness correction is determined and applied to correct the sample image.

3. The method according to claim 1, wherein the brightness correction specification indicates the brightness fluctuation as a function of a position relative to a centre of the bottom.

4. The method according to claim 3, wherein the sample well has a circular cross-section and that the function is an exclusively radial function which denotes the distance from the centre of the bottom.

5. The method according to claim 1, wherein in steps (b) and (d) the imaging is effected along an optical axis and the sample well is moved relative to the optical axis in step (b) by means of a sample shifting mechanism and wherein the brightness correction specification indicates the brightness fluctuation as a function of the setting of the sample shifting mechanism.

6. The method according to claim 5, wherein the brightness correction specification indicates the brightness fluctuation as a function of Cartesian coordinates.

7. The method according to claim 1, wherein the brightness correction specification indicates the brightness fluctuation as a function of an objective used for the imaging in step (b).

8. The method according to claim 7, wherein a plurality of objectives having different numerical apertures are made available for the imaging in step (b), the reference measurement in step (d) is carried out with one of the objectives, and wherein the brightness correction specification indicates the brightness fluctuation as a function of a shading strength factor which is dependent on the numerical aperture of the objective actually used to image the sample well.

9. The method according to claim 8, wherein the reference measurement in step (d) is carried out with one of the objectives having the smallest numerical aperture among the plurality of objectives.
